(19) United States
(12) Patent Application Publication
(10) Pub. No.: US 2011/0155972 A1
(43) Pub. Date: Jun. 30, 2011

(54) ONE SILICON-ALUMINATE LIGHT-CONVERSION FLUORESCENCE MATERIAL CO-ACTIVATED WITH HALOGEN FOR WHITE-LIGHT LED

(75) Inventor: Jiang Hong Wu, Hong Kong (HK)

(73) Assignee: Hong Tai Trade Limited, Hong Kong (HK)

(21) Appl. No.: 12/649,364

(22) Filed: Dec. 30, 2009

(51) Int. Cl. G02B 5/23

(52) U.S. Cl. 252/586

(57) ABSTRACT

One silicon-aluminate light conversion fluorescence material co-activated with halogen for white-light LED, which features a general formula as R₍₃₋ₐ₎M₃N₅CO₁₇:Reₐ,X_{b}, where R is one or more selected from the oxide or hydroxide or oxalate or carbonate of La, Y, Lu, Gd, Tb, Nd, Ho elements, M is one or more selected from the carbonate, hydroxide, fluoride and or/chloride of Ca, Mg, Ba, Sr, Zn elements, C is the oxide of Si, Ge, N is one or more selected from the oxide or hydroxide or oxalate or carbonate or fluoride of B, Al, Ga and In elements, Re is the activator which is one or more selected from the oxide, hydroxide, oxalate or carbonate of Ce, Dy, Pr, Eu, Tm, Er, Sm, Yb, Sc, X is co-activator which is one or more selected from AlF₃, CaF₂, MgF₂, BaF₂, SrF₂ and ZnCl₂, as well as 0.001≦a≦0.5, 0.01≦b≦1.

### BACKGROUND OF THE INVENTION

1. Technical Field

This invention relates to one silicon-aluminate light conversion fluorescence material co-activated with halogen for white-light LED, which is used on blue-light-emitting chip to form white LED and illuminates white light by means of light conversion and combination. It belongs to the field of semiconductor lighting source.

2. Description of Related Art

As one new type, high-efficient solid-state lighting source, Semiconductor lighting source is a novel lighting source of the 21^{st} century in terms of the features of long service life, energy saving, environmentally friendly and miniaturation. Thereby light LED attracts the world attention in lighting market under the background of worldwide energy shortage.

In 1997 Nichia Chemical Industry published one material, chemical formula as Y₃AL₅O₁₂:Ce³⁺ (YAG) which is also named Yttrium Aluminum Garnet in its U.S. Pat. No. 5,998,925 applied to USPTO. It can match the nitride LED developed by Nichia own to form white light LED. This kind of fluorescent powder can absorb blue light of 450˜470 nm wave-length to get excited and emit yellow light of 550˜560 nm wave-length, where the left blue light and the conversed yellow light combine to yield white light. Then the generated white-light LED features lost cost, high efficiency, as well as the main disadvantages including poor color rendering, the thickness of coating critical to white light and poor uniformity.

U.S. Pat. No. 6,669,866 introduces one fluorescence material, chemical formula as Tb₃Al₅O₁₂:Ce³⁺ (Abbr: TAG) which is also named Terbium Aluminum Game whose main defects are high-cost, expensive Terbium and poorer light intensity than YAG.

China patent 0213094913 introduces one material, chemical formula as R_{(3-x-y)}M₅O₁₂:Ceₓ,R′_{y}, whereas R is one or more selected from Y, Gd, Lu, Sc, La and Sm, M is one or more selected from B, Al, Ga, In, P, Ge and Zn, R′ can be one or more selected from Tb, Eu, Dy, Pr and Mn. Compared to the above-mentioned Y₃Al₅O₁₂:Ce³⁺ (YAG), this fluorescence powder provides improved color rendering property and no-higher conversion efficiency of blue light, as well as lower light intensity.

U.S. Pat. No. 6,809,347 published one fluorescence powder, chemical formula as (2-x-y)SrOx(Ba,Ca)O(1-a-b-c-d)SiO₂aP2O5bAl₂O₃cB₂O₃dGeO₂:yEu²⁺(0.01≦x<1.6; 0<y<0.5; x+y≦1.6; 0≦a,b,c,d<0.5), whereas alkali-earth silicate containing Eu is used and Sr₂SiO₄ or Ba₂SiO₄ is the Sr or Ba substitute of parent substance to P, Al, B or Ge. This fluorescence powder also uses blue light to excite and emit some reddish orange whose color rendering index is 82 by the highest. The light intensity is lower and the white color is unnatural.

US patent US20060027781 published one fluorescence powder, chemical formula as A₂SiO₄:Eu²⁺, D(A=Sr, Ca, Mg, Zn, Cd, D=0.1˜0.2 mol % F, Cl, Br, I, P, S, N), which features good color rendering and high light efficiency, and can produce low-temperature white light. Its defects include coarse granules, moisture absorption, needing to combine physically two types of powders which cannot be mixed evenly and is prone to layering, being unsuitable for dispensing, the light intensity of yellow powder and green powder being lower than that of YAG, it contains Cd in red powder which is not environmentally friendly.

### BRIEF SUMMARY OF THE INVENTION

In consideration of the disadvantages of present technology, this invention introduces one type of novel silico-aluminate light-conversion fluorescence material co-started with halogen for white-light LED. It features high light intensity, high color rendering, low cost, resistance to ageing and light loss, etc. It is one fluorescence material of following chemical formula as R₍₃₋ₐ₎M₃N₅CO₁₇:Reₐ, X_{b}, where: R is one or more selected from the oxide or hydroxide or oxalate or carbonate of La, Y, Lu, Gd, Tb, Nd, Ho elements, M is one or more selected from the carbonate, hydroxide, fluoride and or/chloride of Ca, Mg, Ba, Sr, Zn elements, C is the oxide of Si, Ge, N is one or more selected from the oxide or hydroxide or oxalate or carbonate or fluoride of B, Al, Ga and In elements, Re is the starter which is one or more selected from the oxide, hydroxide, oxalate or carbonate of Ce, Dy, Pr, Eu, Tm, Er, Sm, Yb, Sc, X is the co-starter which is one or more selected from AlF₃, CaF₂, MgF₂, BaF₂, SrF₂ and ZnCl₂, as well as 0.001≦a≦0.5, 0.01≦b≦1. Simultaneously, AlF₃, CaF₂, MgF₂, BaF₂, SrF₂ and ZnCl₂ can also play the role of fluxing agent.

The difference between this invention and the above-mentioned patents:
1. Their molecular structural formula is different. The structure of this patented differs from both that of Y₃Al₅O₁₂:Ce³⁺(YAG) of Nichia and that of chemical formula Tb₃Al₅O₁₂:Ce3+(Abbr: TAG) introduced by U.S. Pat. No. 6,669,866, also it differs from the structure of alkali-earth silicon-aluniate of chemical formula as (2-x-y)SrOx(Ba,Ca)O(1-a-b-c-d)SiO₂aP2O5bAl₂O₃cB₂O₃dGeO₂:yEu²⁺ of the fluorescence powder published by U.S. Pat. No. 6,809,347. Furthermore, it differs from the silicate structure of the fluorescence powder of chemical formula as A2SiO4:Eu²⁺, D published by patent US20060027781. The structure of this patented is (Y₁₋ⱼGdⱼ)₃₋ₐ(Sr_{1-c-d}Ba_{c}Ca_{d})₃(Al₁₋ₖGaₖ)₅SiO₁₇:(Ce₁₋ᵢ₋ₚPrᵢEuₚ)ₐ, (F_{1-z}Cl_{z})_{b}, which is more stable, more resistant to water, more resistant to acid-base compared to silicate structure.
2. This invention selects many kinds of co-activators but Ce including co-activator of Eu, Pr as well as co-activating elements of halogen elements as F, Cl. It features wide lighting spectral bands, high light intensity and can present higher conversion efficiency of blue light.
3. This patented material features a polyhedron structure belonging to silico-aluminate Yttrium Carnet, which is more stable, more resistant to oxidation, more resistant to acid than YAG. Also it is more resistant to moisture, more resistant to acid-base, more resistant to hydrolysis and better structural stability compared to the structure patented in U.S. Pat. No. 6,809,347 and US20060027781. Also it can show wider color range from green to orange red and can meet the requirement of color temperature change from 10000K to 2700K.

The light conversion fluorescence material for white light LED described in this patent features that it can be excited by lights from ultraviolet to blue in the range of 250 nm˜490 nm.

The light conversion fluorescence material for white light LED described in this patent features that the emitted visible spectrum ranges from 450˜700 nm of a peak at 520 nm˜630 nm.

The light conversion fluorescence material for white light LED described in this patent features that it can be expressed in a general formula as (Y₁₋ⱼGdⱼ)₃₋ₐ(Sr_{1-c-d}Ba_{c}Ca_{d})₃(Al₁₋ₖGaₖ)₅SiO₁₇:(Ce₁₋ᵢ₋ₚPrᵢEup)ₐ, (F_{1-z}Cl_{z})_{b}, where 0.001≦a≦0.5, 0.01≦b≦1, 0.001≦c≦0.9, 0.001≦d≦0.9, 0.001≦j≦0.9, 0.01≦k≦0.5, 0.001≦i≦0.1, 0.001≦p≦0.5, 0.1≦z≦0.5. Here, Pr is co-avtivator of emitting peak in the orange-red area at 610 nm which forms doublets with the peak of Ce in the yellow area at 530˜583 nm, so two primary colors of lighting occur in the same matrix and can form three primary colors of lighting with blue light from blue-light IC which improves the color rendering index. Moreover, the two primary colors occur in the same matrix to keep the homogeneity, consistency and stability of the color.

The light conversion fluorescence material for white light LED described in this patent features that X is co-activators F and Cl whose emission spectrum moves towards short wave as z decreases in the range of 0.1≦z≦0.125 and moves towards long wave as z increases in the range of 0.125≦z≦0.5. The emitting peak occurs in the area of 530˜610 nm and its light intensity gets stronger as b increases in the range of 0.01≦b≦1.

The light conversion fluorescence material for white light LED described in this patent features that the peak value of emission spectrum can be changed through adjusting the ratio of Y to Gd, which moves towards long wave as j increases and moves towards short wave length as j decreases in the range of 0.001≦j≦0.9 and occurs in the range of 530˜610 nm.

The light conversion fluorescence material for white light LED described in this patent features that the peak value of emission spectrum can be changed through adjusting the ratio of Al to Ga, which moves towards short wavelenth as k increases and moves towards long wave as k decreases in the range of 0.01≦k≦0.5 and occurs in the range of 530˜610 nm.

The preparation method of light conversion fluorescence material for white light LED described in this patent features that all the constituents are weighed according to the mole ratio defined in the structural formula and mixed evenly before sintered at 1250˜1500° C. for 3˜5 hours under mixture of nitrogen and hydrogen, then the loose powder is yielded after being cooled down of mean grain size D₅₀ of 4˜7 μm.

The preparation method of light conversion fluorescence material for white light LED described in this patent features that carbonate or oxalate can be selected as raw materials to prepare superfine fluorescence material because carbonate or oxalate can be decomposed by heat to yield thinner granule after sintering. But carbonate ion and oxalate ion can be reduced to elementary carbon under reducing atmosphere which results in carbon pollution. So the sintering process can be carried out through two steps: first, it is sintered at 1000° C. for 2 hours under oxidizing atmosphere before cooled down; second, it is then sintered at 1250˜1500° C. for 3˜5 hours to form loose powder of average grain size D₅₀ of 2˜4 μm.

The preparation method of light conversion fluorescence material for white light LED described in this patent features that the yielded powder is treated and coated with organic siloxane to gain the property of age resistance and light-decay resistance, where organic siloxane solution of 0.5% concentration in isopropanol is used to treat the surface of the fluorescence powder to form a membrane of 1˜2 nm thickness and then dried at 100° C. to get a coating resistant to ageing and light loss.

The light conversion fluorescence material for white light LED described in this patent features that it is made into coating with epoxy resin or silicon resin and then coated on IC for 410˜490 nm light before sealed with transparent epoxy resin or silicon resin. Once IC is powered up, it gives out blue light and excites fluorescence material to emit yellow light of peak value at 530˜610 nm which can combine with the transmitted blue light from a white light source.

### BRIEF DESCRIPTION OF THE SEVERAL VIEWS OF THE DRAWINGS

FIG. 1 shows that the peak value of emission spectrum can be changed through adjusting the ratio of Y to Gd, which can move towards short wave as j increases or towards long wave as j decreases in the range of 0.001≦j≦0.9.

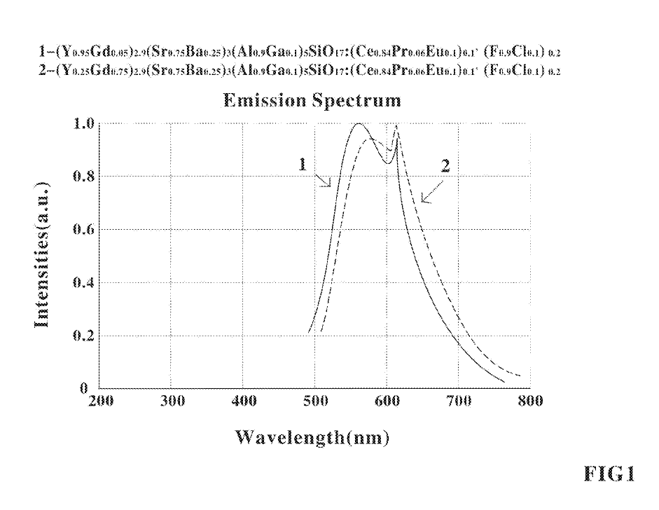

FIG. 2 shows that the peak value of emission spectrum can be changed through adjusting the ratio of Al to Ga, which can move towards short wave as k increases or towards long wave as k decreases in the range of 0.01≦k≦0.5.

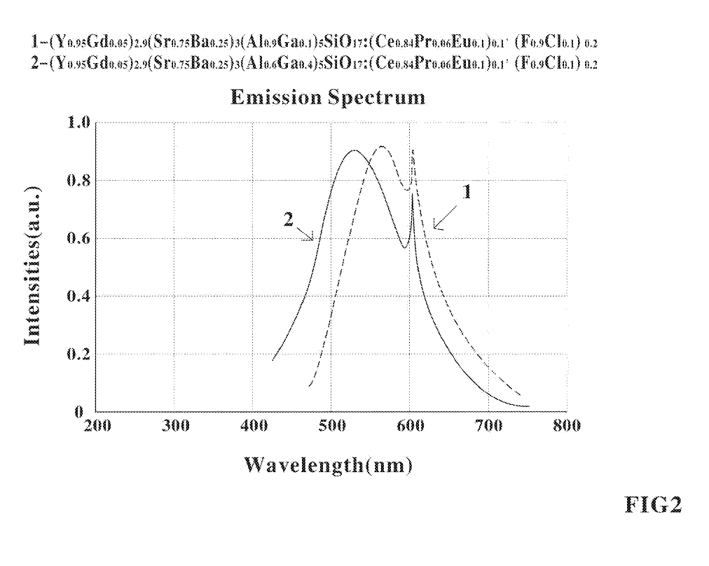

FIG. 3 shows that compared to YAG:Ce³⁺, this patented fluorescence material Pr is co-starter and there is emission peak in the orange-red area of 610 nm which forms doublet with peak in the yellow light area of Ce at 530 nm˜583 nm. So two primary colors of lighting occur in the same matrix which forms three primary colors of lighting with blue light from blue-light chip, though there are only two primary colors for YAG:Ge³⁺ material.

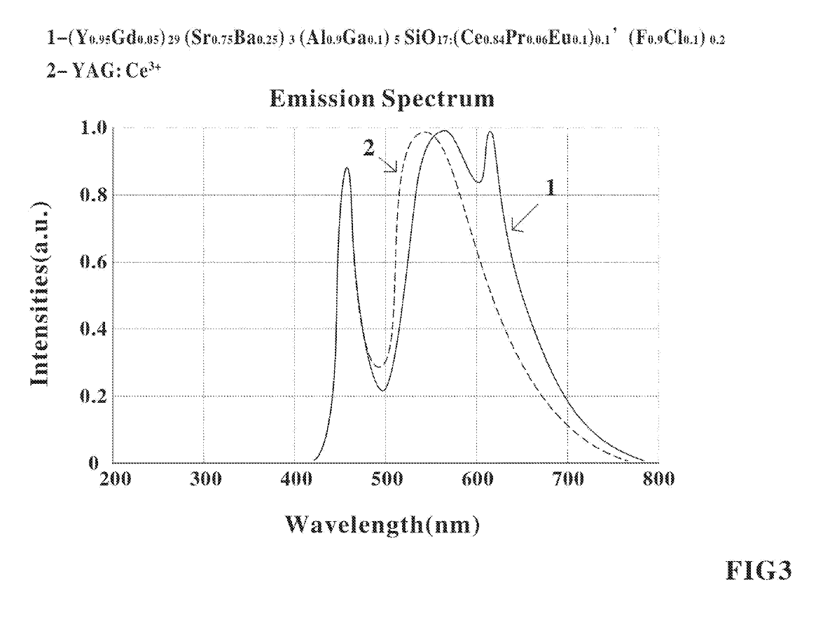

FIG. 4 shows that this patented fluorescence material features that X is co-activator of F and Cl, and the emission spectrum can move towards short wave as z decreases in the range of 0.1≦z≦0.125, or move towards long wave as z increases in the range of 0.125≦z≦0.5.

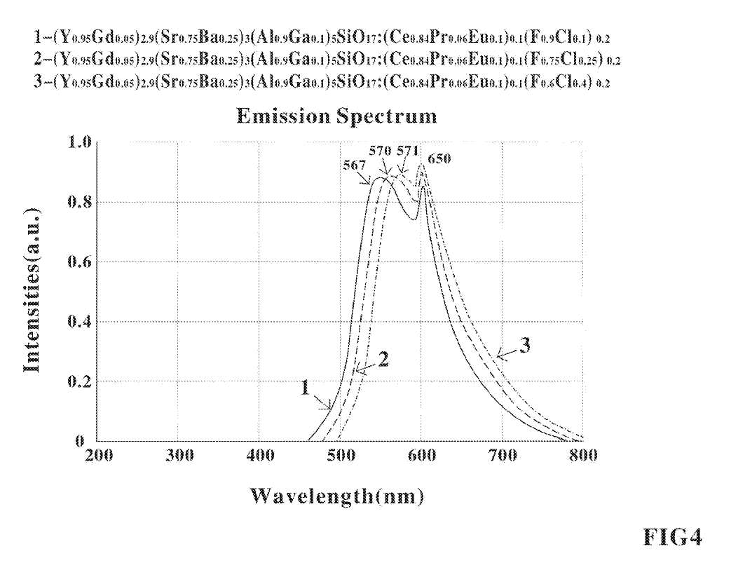

FIG. 5 shows that this patented fluorescence material features that X is co-activator of F and Cl, and the emission spectrum gets stronger as b increases in the range of 0.01≦b≦1, where the highest light intensity occurs at b=0.4.

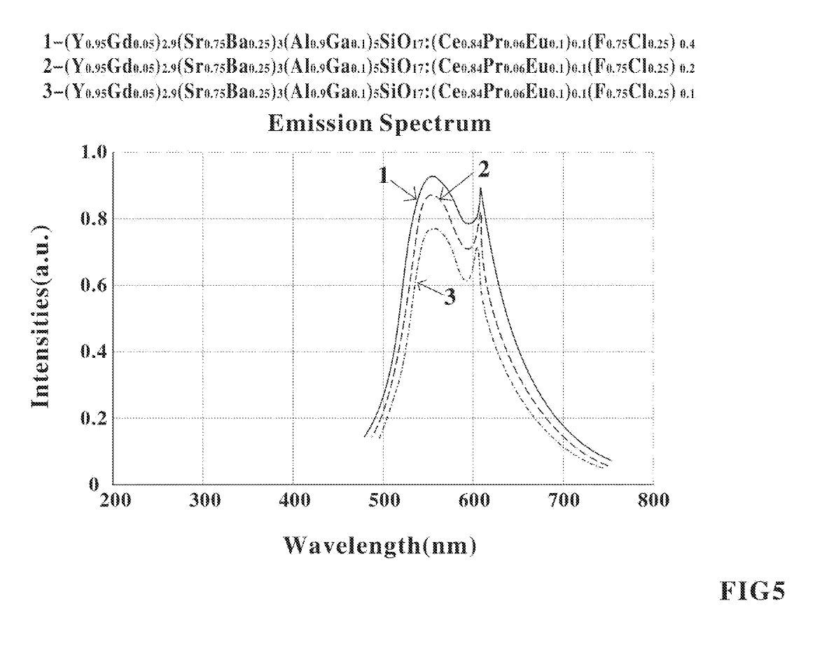

### DETAILED DESCRIPTION OF THE INVENTION

In order to explain this patented fluorescence material and thereof preparation methods, following examples are illustrated though the scope of this patent is not limited to these examples.

### Example 1

### Preparation of (Y_{0.95}Gd_{0.05})_{2.9}(Sr_{0.75}Ba_{0.25})₃(Al_{0.9}Ga_{0.1})₅SiO₁₇:(Ce_{0.84}Pr_{0.06}Eu_{0.1})_{0.1}, (F_{0.9}Cl_{0.1})_{0.2}

Reagents and chemicals are weighed as following metering:

| | |
|---|---|
| Y₂O₃(5N) | 1.3775 mol |
| Gd₂O₃(4N) | 0.145 mol |
| Al(OH)₃ | 4.5 mol |
| Ga₂O₃(4N) | 0.25 mol |
| CeO2(4N) | 0.094 mol |
| Eu2O3 | 0.05 mol |
| Pr₆O₁₁(4N) | 0.001 mol |
| SiO₂(4N) | 1.0 mol |
| SrCO₃ | 2.25 mol |
| BaCO₃ | 0.75 mol |
| AlF₃(4N) | 0.03 mol |
| BaF2(4N) | 0.05 mol |
| BaCl2(4N) | 0.01 mol |

After the weighed materials are ground and mixed evenly, charge them into high a purity alumina crux before sintered at 1350˜1500° C. for 3˜5 hours under an atmosphere of hydrogen-nitrogen mixture (volume ratio is 75%) to yield loose powder of mean grain size at D₅₀ of 4˜7 μm, Then organic siloxane solution of 0.5% concentration in isopropanol is used to treat the surface of the yielded fluorescence powder to form a membrane of 1˜2 nm of thickness and then dried at 100° C. to get a coating resistant to ageing and light loss. It emits yellow light of 567 nm and displays strong lighting peak at 610 nm once excited by blue light of 460 nm.

### Example 2

### Preparation of (Y_{0.25}Gd_{0.75})_{2.9}(Sr_{0.75}Ba_{0.25})₃(Al_{0.9}Ga_{0.1})₅SiO₁₇:(Ce_{0.84}Pr_{0.06}Eu_{0.1})_{0.1}, (F_{0.9}Cl_{0.1})_{0.2}

Reagents and chemicals are weighed as following metering:

| | |
|---|---|
| Y₂O₃(5N) | 0.3625 mol |
| Gd₂O₃(4N) | 1.0875 mol |
| Al(OH)₃ | 4.5 mol |
| Ga₂O₃(4N) | 0.25 mol |
| CeO2(4N) | 0.084 mol |
| Eu2O3 | 0.01 mol |
| Pr₆O₁₁(4N) | 0.001 mol |
| SiO₂(4N) | 1.0 mol |
| SrCO₃ | 2.25 mol |
| BaCO₃ | 0.75 mol |
| AlF₃(4N) | 0.03 mol |
| BaF2(4N) | 0.05 mol |
| BaCl2(4N) | 0.01 mol |

After the weighed materials are ground and mixed evenly, charge them into a high purity alumina crux before sintered at 1350˜1500° C. for 3˜5 hours under an atmosphere of hydrogen-nitrogen mixture(volume ratio is 75%) to yield loose powder of mean grain size D₅₀ of 4˜7 μm, Then organic siloxane solution of 0.5% concentration in isopropanol is used to treat the surface of the fluorescence powder to form a membrane of 1˜2 nm of thickness and then dried at 100° C. to get a coating resistant to ageing and light loss. It emits yellow light of 575 nm and displays strong lighting peak at 610 nm once excited by blue light of 460 nm.

### Example 3

### Preparation of (Y_{0.95}Gd_{0.05})_{2.9}(Sr_{0.75}Ba_{0.25})₃(Al_{0.6}Ga_{0.4})₅SiO₁₇:(Ce_{0.84}Pr_{0.06}Eu_{0.1})_{0.1}, (F_{0.9}Cl_{0.1})_{0.2}

Reagents and chemicals are weighed as following metering:

| | |
|---|---|
| Y₂O₃(5N) | 1.3775 mol |
| Gd₂O₃(4N) | 0.145 mol |
| Al(OH)₃ | 3.0 mol |
| Ga₂O₃(4N) | 1.0 mol |
| CeO2(4N) | 0.084 mol |
| Eu2O3 | 0.01 mol |
| Pr₆O₁₁(4N) | 0.001 mol |
| SiO₂(4N) | 1.0 mol |
| SrCO₃ | 2.25 mol |
| BaCO₃ | 0.75 mol |
| AlF₃(4N) | 0.03 mol |
| BaF2(4N) | 0.05 mol |
| BaCl2(4N) | 0.01 mol |

After the weighed materials are ground and mixed evenly, charge them into a high purity alumina crux before sintered at 1350˜1500° C. for 3˜5 hours under an atmosphere of hydrogen-nitrogen mixture (volume ratio is 75%) to yield loose powder of mean grain size D₅₀ of 4˜7 μm, Then organic siloxane solution of 0.5% concentration in isopropanol is used to treat the surface of the fluorescence powder to form a membrane of 1˜2 nm of thickness and then dried at 100° C. to get a coating resistant to ageing and light loss. It emits yellow light of 540 nm and displays strong lighting peak at 610 nm once excited by blue light of 460 nm.

### Example 4

### Preparation of (Y_{0.95}Gd_{0.05})_{2.9}(Sr_{0.75}Ba_{0.25})₃(Al_{0.9}Ga_{0.1})₅SiO₁₇:(Ce_{0.84}Pr_{0.06}Eu_{0.1})_{0.1}, (F_{0.6}Cl_{0.4})_{0.2}

Reagents and chemicals are weighed as following metering:

| | |
|---|---|
| Y₂O₃(5N) | 1.3775 mol |
| Gd₂O₃(4N) | 0.145 mol |
| Al(OH)₃ | 4.5 mol |
| Ga₂O₃(4N) | 0.25 mol |
| CeO2(4N) | 0.094 mol |
| Eu2O3 | 0.05 mol |
| Pr₆O₁₁(4N) | 0.001 mol |
| SiO₂(4N) | 1.0 mol |
| SrCO₃ | 2.25 mol |
| BaCO₃ | 0.75 mol |
| AlF₃(4N) | 0.015 mol |
| BaF2(4N) | 0.04 mol |
| BaCl2(4N) | 0.04 mol |

After the weighed materials are ground and mixed evenly, charge them into a high purity alumina crux before sintered at 1350˜1500° C. for 3˜5 hours under an atmosphere of hydrogen-nitrogen mixture (volume ratio is 75%) to yield loose powder of mean grain size D₅₀ of 4˜7 μm, Then organic siloxane solution of 0.5% concentration in isopropanol is used to treat the surface of the fluorescence powder to form a membrane of 1˜2 nm of thickness and then dried at 100° C. to get a coating resistant to ageing and light loss. It emits yellow light of 570 nm and displays strong lighting peak at 610 nm once excited by blue light of 460 nm.

### Example 5

### Preparation of (Y_{0.95}Gd_{0.05})_{2.9}(Sr_{0.75}Ba_{0.25})₃(Al_{0.9}Ga_{0.1})₅SiO₁₇:(Ce_{0.84}Pr_{0.06}Eu_{0.1})_{0.1}, (F_{0.75}Cl_{0.25})_{0.2}

Reagents and chemicals are weighed as following metering:

| | |
|---|---|
| Y₂O₃(5N) | 1.3775 mol |
| Gd₂O₃(4N) | 0.145 mol |
| Al(OH)₃ | 4.5 mol |
| Ga₂O₃(4N) | 0.25 mol |
| CeO2(4N) | 0.094 mol |
| Eu2O3 | 0.05 mol |
| Pr₆O₁₁(4N) | 0.001 mol |
| SiO₂(4N) | 1.0 mol |
| SrCO₃ | 2.25 mol |
| BaCO₃ | 0.75 mol |
| AlF₃(4N) | 0.03 mol |
| BaF2(4N) | 0.03 mol |
| BaCl2(4N) | 0.025 mol |

After the weighed materials are ground and mixed evenly, charge them into a high purity alumina crux before sintered at 1350˜1500° C. for 3˜5 hours under an atmosphere of hydrogen-nitrogen mixture (volume ratio is 75%) to yield loose powder of mean grain size D₅₀ of 4˜7 μm, Then organic siloxane solution of 0.5% concentration in isopropanol is used to treat the surface of the fluorescence powder to form a membrane of 1˜2 nm of thickness and then dried at 100° C. to get a coating resistant to ageing and light loss. It emits yellow light of 572 nm and displays strong lighting peak at 610 nm once excited by blue light of 460 nm.

### Example 6

### Preparation of (Y_{0.95}Gd_{0.05})_{2.9}(Sr_{0.75}Ba_{0.25})₃(Al_{0.9}Ga_{0.1})₅SiO₁₇:(Ce_{0.84}Pr_{0.06}Eu_{0.1})_{0.1}, (F_{0.75}Cl_{0.25})_{0.4}

Reagents and chemicals are weighed as following metering:

| | |
|---|---|
| Y₂O₃(5N) | 1.3775 mol |
| Gd₂O₃(4N) | 0.145 mol |
| Al(OH)₃ | 4.5 mol |
| Ga₂O₃(4N) | 0.25 mol |
| CeO2(4N) | 0.094 mol |
| Eu2O3 | 0.05 mol |
| Pr₆O₁₁(4N) | 0.001 mol |
| SiO₂(4N) | 1.0 mol |
| SrCO₃ | 2.25 mol |
| BaCO₃ | 0.75 mol |
| AlF₃(4N) | 0.06 mol |
| BaF2(4N) | 0.06 mol |
| BaCl2(4N) | 0.05 mol |

After the weighed materials are ground and mixed evenly, charge them into a high purity alumina crux before sintered at 1350˜1500° C. for 3˜5 hours under an atmosphere of hydrogen-nitrogen mixture (volume ratio is 75%) to yield loose powder of mean grain size D₅₀ of 4˜7 μm, Then organic siloxane solution of 0.5% concentration in isopropanol is used to treat the surface of the fluorescence powder to form a membrane of 1˜2 nm of thickness and then dried at 100° C. to get a coating resistant to ageing and light loss. It emits yellow light of 572 nm and displays strong lighting peak at 610 nm whose light intensity is 110% of that of example 5 once excited by blue light of 460 nm.

### Example 7

### Preparation of (Y_{0.95}Gd_{0.05})_{2.9}(Sr_{0.7}5Ba_{0.25})₃(Al_{0.9}Ga_{0.1})₅SiO₁₇:(Ce_{0.84}Pr_{0.06}Eu_{0.1})_{0.1}, (F_{0.9}Cl_{0.1})_{0.2}

Reagents and chemicals are weighed as following metering:

| | |
|---|---|
| Y₂(C₂O₄)₃(5N) | 1.3775 mol |
| Gd₂(C₂O₄)₃(4N) | 0.145 mol |
| Al(OH)₃ | 4.5 mol |
| Ga₂(C₂O₄)₃(4N) | 0.25 mol |
| Ce(C₂O₄)₂(4N) | 0.094 mol |
| Pr₆(C₂O₄)₁₁(4N) | 0.001 mol |
| Eu2(C₂O₄)₃(4N) | 0.01 mol |
| SiO₂(4N) | 1.0 mol |
| SrCO₃ | 2.25 mol |
| BaCO₃ | 0.75 mol |
| AlF₃(4N) | 0.03 mol |
| BaF2(4N) | 0.05 mol |
| BaCl2(4N) | 0.01 mol |

Y₂(C₂O₄)₃(5N) 1.3775 mol, Gd₂(C₂O₄)₃(4N) 0.145 mol, Al(OH)₃ 4.5 mol, Ga₂(C₂O₄)₃(4N) 0.25 mol, Ce (C₂O₄)₂(4N) 0.094 mol, Pr₆(C₂O₄)₁₁(4N) 0.001 mol, Eu2 (C₂O₄)₃(4N) 0.01 mol, SiO₂(4N) 1.0 mol, SrCO₃ 2.25 mol, BaCO₃ 0.75 mol are weighed accurately and are ground and mixed evenly, then charge them into a high purity alumina crux before sintered at 800˜1000° C. for 2˜3 hours under an atmosphere of oxidation to decompose oxalate and carbonate before cooled down. Then the material is taken out and added with 0.03 mol AlF₃(4N), 0.05 mol BaF2(4N), 0.01 mol BaCl2(4N) before grinded and mixed evenly and then charged into high purity alumina crux before sintered at 1350˜1500° C. for 3˜5 hours under an atmosphere of hydrogen-nitrogen mixture (volume ratio is 75%) to yield loose powder of mean grain size D₅₀ of 4˜7 μm, Then organic siloxane solution of 0.5% concentration in isopropanol is used to treat the surface of the fluorescence powder to form a membrane of 1˜2 nm of thickness and then dried at 100° C. to get a coating resistant to ageing and light loss. It emits yellow light of 568 nm and displays strong lighting peak at 610 nm once excited by blue light of 460 nm.

### Example 8

### The Fluorescence Materials Prepared in Examples 1˜7 for White Light LED are Sealed on 1 w High-Power IC with Epoxy Resin by a Weight Ratio of 16% for the Experiment, the Results are as Follows

| | color | color | color | | high- | high |
|---|---|---|---|---|---|---|
| Powder | coordinate | coordinate | temperature | Luminous | temperature | temperature |
| example | x | y | k | flux lm | ageing 100 H | ageing 350 H |
| Example 1 | 0.318 | 0.301 | 6480 | 61 | 63 | 60 |
| Example 2 | 0.378 | 0.365 | 3600 | 68 | 70 | 69 |
| Example 3 | 0.272 | 0.308 | 9800 | 63 | 64 | 63 |
| Example 4 | 0.330 | 0.328 | 5506 | 65 | 66 | 65 |
| Example 5 | 0.322 | 0.335 | 5600 | 63 | 64 | 63 |
| Example 6 | 0.335 | 0.340 | 6500 | 70 | 71 | 69 |
| Example 7 | 0.320 | 0.325 | 6500 | 62 | 62 | 62 |

These data reveals that the fluorescence powder coated with organic siloxane features resistance to ageing, non-discolouring, very little attenuation, high stability. The fluorescence powder made of oxalate is superfine without the need of grinding, and is more stable.

1. One silicon-aluminate light conversion fluorescence material co-started with halogen for white-light LED, which features a general formula as R₍₃₋ₐ₎M₃N₅CO₁₇:Reₐ,X_{b}, where R is one or more selected from the oxide or hydroxide or oxalate or carbonate of La, Y, Lu, Gd, Tb, Nd, Ho elements, M is one or more selected from the carbonate, hydroxide, fluoride and or/chloride of Ca, Mg, Ba, Sr, Zn elements, C is the oxide of Si, Ge, N is one or more selected from the oxide or hydroxide or oxalate or carbonate or fluoride of B, Al, Ga and In elements, Re is the starter which is one or more selected from the oxide, hydroxide, oxalate or carbonate of Ce, Dy, Pr, Eu, Tm, Er, Sm, Yb, Sc, X is the co-starter which is one or more selected from AlF₃, CaF₂, MgF₂, BaF₂, SrF₂ and ZnCl₂, as well as 0.001≦a≦0.5, 0.01≦b≦1.

2. The light conversion fluorescence material for white light LED described according to claim 1, which features a general formula of (Y₁₋ⱼGdⱼ)₃₋ₐ(Sr_{1-c-d}Ba_{c}Ca_{d})₃(Al₁₋ₖGaₖ)₅SiO₁₇:(Ce₁₋ᵢ₋ₚPrᵢEuₚ)ₐ, (F_{1-z}Cl_{z})_{b}, where 0.001≦a≦0.5, 0.01≦b≦1, 0.001≦c≦0.9, 0.001≦d≦0.9, 0.001≦j≦0.9, 0.01≦k≦0.5, 0.001≦i≦0.1, 0.001≦p≦0.5, 0.1≦z≦0.5.

3. The light conversion fluorescence material for white light LED described according to claim 1, which features that Pr is co-starter whose emission peak occurs in the orange-red area of 610 nm and forms double peak with the peak of Ce in yellow area of 530˜610 nm.

4. The light conversion fluorescence material for white light LED described according to claim 1, which features that Eu is co-starter whose emission peak occurs in the yellow area of 520˜630 nm and forms a superposition with the peak of Ce in yellow area of 530˜610 nm.

5. The light conversion fluorescence material for white light LED described according to claim 1, which features that X is co-starter of F and Cl, whose emission spectrum can move towards short wave as z value decreases in the range of 0.1≦z≦0.125, and can move towards long wave as z value increases in the range of 0.125≦z≦0.5. Its emission peak occurs at 520 nm˜630 nm and the light intensity gets stronger as b value increases in the range of 0.01≦b≦1.

6. The light conversion fluorescence material for white light LED described according to claim 1, which features that the peak value of emission spectrum can be changed through adjusting the ratio of Y to Gd, which can move towards long wave as j increases or towards short wave as j decreases in the range of 0.001≦j≦0.9. The emission peak occurs at 520˜630 nm.

7. The light conversion fluorescence material for white light LED described according to claim 1, which features that the peak value of emission spectrum can be changed through adjusting the ratio of Al to Ga, which can move towards short wave as k increases or moves towards long wave as k decreases in the range of 0.01≦k≦0.5. The emission peak occurs at 520˜630 nm.

8. The preparation method of light conversion fluorescence material for white light LED described according to claim 1, which features that all the constituents are weighed according to the mole ratio defined in the structural formula and mixed evenly before sintered at 1250˜1500° C. for 3˜5 hours under mixture of nitrogen and hydrogen, then the loose powder is yielded after cooled down of mean grain size D₅₀ of 4˜7 μm.

9. The preparation method of light conversion fluorescence material for white light LED described according to claim 1, which features that when carbonate or oxalate is selected as the raw materials, and the sintering process should be carried out through two steps: first, it is sintered at 1000° C. for 2 hours under oxidizing atmosphere before cooled down; second, it is then sintered at 1250˜1500° C. for 3˜5 hours to form loose powder of average grain size D₅₀ of 3˜5 μm.

10. The preparation method of light conversion fluorescence material for white light LED described according to claim 1, which features that the yielded powder is treated and coated with organic siloxane to gain the property of ageing resistance and light-decay resistance.

11. The light conversion fluorescence material for white light LED described according to claim 1, which features that it can be made to form white light LED, where it is made into coating with epoxy resin or silicon resin and then coated on chip for 410˜490 nm light before sealed with transparent epoxy resin or silicon resin. Once chip is powered up, it gives out blue light and excites fluorescence material to emit a yellow light of peak value at 520˜630 nm which can combine with the transmitted blue light from white light source.
